(19) United States
(12) Patent Application Publication
(10) Pub. No.: US 2001/0033064 A1
(43) Pub. Date: Oct. 25, 2001

(54) Gas grill caddy

(75) Inventor: John D. Sinchok, Peninsula, OH (US)

Correspondence Address: Roger D. Emerson, Fourteenth Floor, One Cascade Plaza, Akron, OH, 44308-1136, US

(73) Assignee: Step2 Corporation, Streetsboro, OH (US)

(21) Appl. No.: 09/761,491

(22) Filed: Jan. 16, 2001

Related U.S. Application Data
(63) Continuation-in-part of application No. 09/311,824, filed on May 13, 1999, now abandoned.
(60) Provisional application No. 60/212,866, filed on Jun. 20, 2000.

(51) Int. Cl. B62B 1/18

(52) U.S. Cl. 280/47.315

(57) ABSTRACT

An inventive caddy is disclosed herein. The invention includes a caddy for transporting cylindrical containers, such as propane gas tanks and bottles of drinking water. The invention includes a frame, at least one wheel and an adjustable and retractable handle. The invention also includes a method for attaching the caddy to a gas grill. The caddy has two grooves which can be received by the support bar of a gas grill. Placement of the grooves upon the support bar prevents the caddy from moving in a lateral direction.

### FIELD OF THE INVENTION

This application is a continuation-in-part of, and therefore claims priority from, U.S. patent application, Ser. No. 09/311,824, entitled GAS GRILL CADDY, filed on May 13, 1999. This invention relates to the field of caddies, and more particularly to a caddy for transporting and storing cylindrical containers, such as gas tanks and bottles of water.

### DESCRIPTION OF THE RELATED ART

The transportation of propane gas tanks has been a recurring problem ever since the introduction of the gas grill. It is well known that people have had to lift, roll, carry, and use large equipment to transport their propane gas tanks back and forth from their vehicles to their gas grills. A full propane gas tank is typically very heavy and thus may cause injury to a person carrying the tank. Furthermore, should the tank be dropped, the supply valve may break off, thereby releasing the pressurized contents, which is obviously undesirable.

Similar problems have also been encountered with bottles of drinking water. The bottles must be frequently moved back and forth from a storage location to a water dispenser located in a person's home or office. The bottles are heavy and difficult to maneuver, which makes transportation of the bottles difficult. Furthermore, should the bottle be dropped, the bottle may break, thereby causing spillage of water therefrom.

The present invention is intended to alleviate the necessity of carrying cylindrical containers, such as gas tanks and bottles of water, thus minimizing the chance that the containers will be dropped. Accordingly, the present invention contemplates a new caddy, which is simple in design, effective in use, and overcomes the foregoing difficulties and others while providing better and more advantageous overall results.

### SUMMARY OF THE INVENTION

In accordance with the present invention, a new and improved caddy is provided for transporting cylindrical containers, such as gas tanks and bottles of water.

In accordance with another aspect of the present invention, the caddy includes a handle, wheels, and a frame having a base and a back member.

In accordance with another aspect of the present invention, the caddy includes an adjustable handle.

In accordance with still another aspect of the present invention, the base has two grooves which are adapted to receive a support bar of an associated gas grill.

One advantage of the current invention is that it is no longer necessary to carry heavy cylindrical containers, such as propane tanks or bottles of water, by hand.

Another advantage of the current invention is that the caddy for the gas tank is attachable to the gas grill.

Yet another advantage of the current invention is that the caddy will sit upright regardless of whether or not a cylindrical container is positioned within the caddy.

Still another advantage of the current invention is that the gas tank does not need to be removed from the caddy in order to attach it to the gas grill.

Still other benefits and advantages of the invention will become apparent to those skilled in the art upon a reading and understanding of the following detailed specification.

### BRIEF DESCRIPTION OF THE DRAWINGS

The invention may take physical form in certain parts and arrangement of parts. Several embodiments of these parts will be described in detail in the specification and illustrated in the accompanying drawings, which form a part of this disclosure and wherein:

FIG. 1 is a perspective view of the caddy;

FIG. 2 is a front view of the caddy showing the gas tank in place;

FIG. 3 is a front view of the caddy without the gas tank;

FIG. 4 is a front view of the caddy with the adjustable handle in an extended position;

FIG. 5 is side view of the caddy with the adjustable handle in an extended position;

FIG. 6 is an exploded front view of the adjustable handle;

FIG. 7 is an exploded side view of the adjustable handle;

FIG. 8 is a side view of another embodiment of the adjustable handle, showing the handle in the extended position;

FIG. 9 is a side view of the handle shown in FIG. 8, but showing the handle in the folded position;

FIG. 10 is a top view of the frame shown in FIG. 6, referencing first and second handle rod guides;

FIG. 11 is a perspective cross-sectional view of the frame taken along line A-A of FIG. 6, showing a second handle rod stop;

FIG. 12 is a perspective cross-sectional view taken along line B-B of FIG. 6, showing a first handle rod stop;

FIG. 13 is a perspective cross-sectional view of a first handle rod taken along line B-B of FIG. 6, showing a first stop bar;

FIG. 14 is a perspective cross-sectional view of a second handle rod taken along line A-A of FIG. 6, showing a second stop bar;

FIG. 15 is a perspective cross-sectional view taken along line A-A of FIG. 6, showing the first handle rod in the extended position, and showing the first stop bar against the first handle rod stop;

FIG. 16 is a perspective cross-sectional view taken along line B-B of FIG. 6, showing the second handle rod in the extended position, and showing the second stop bar against the second handle rod stop; and,

FIG. 17 is a perspective view of the caddy attached to an associated gas grill.

### DESCRIPTION OF THE INVENTION

Referring now to the drawings, which are for purposes of illustrating embodiments of the invention only, and not for purposes of limiting the same, the caddy is shown is association with a gas tank. However, the caddy can be used in association with other cylindrical containers, such as bottles of water, and more particularly, the conventional 5 gallon bottle of drinking water.

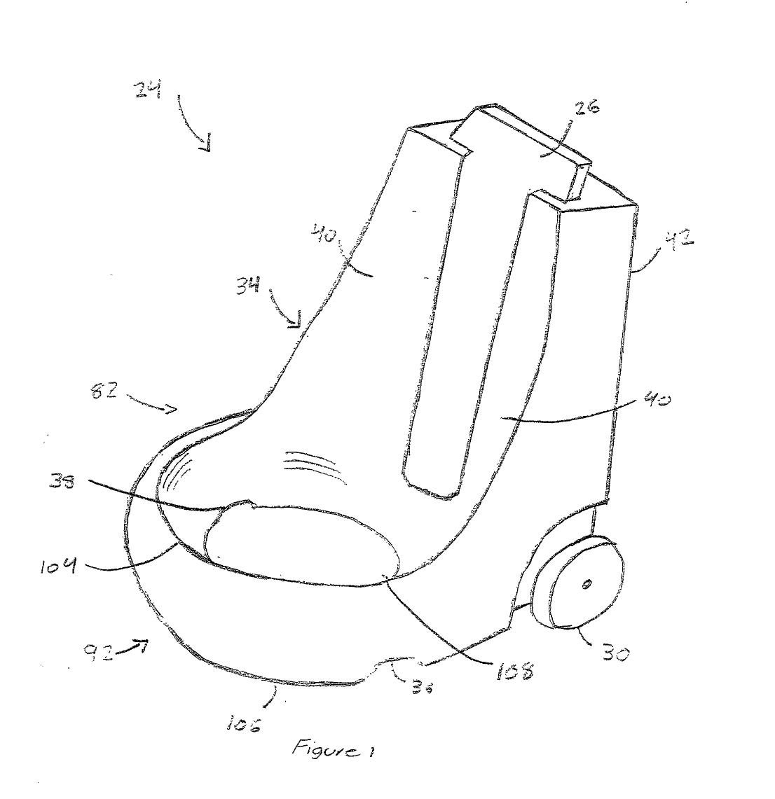

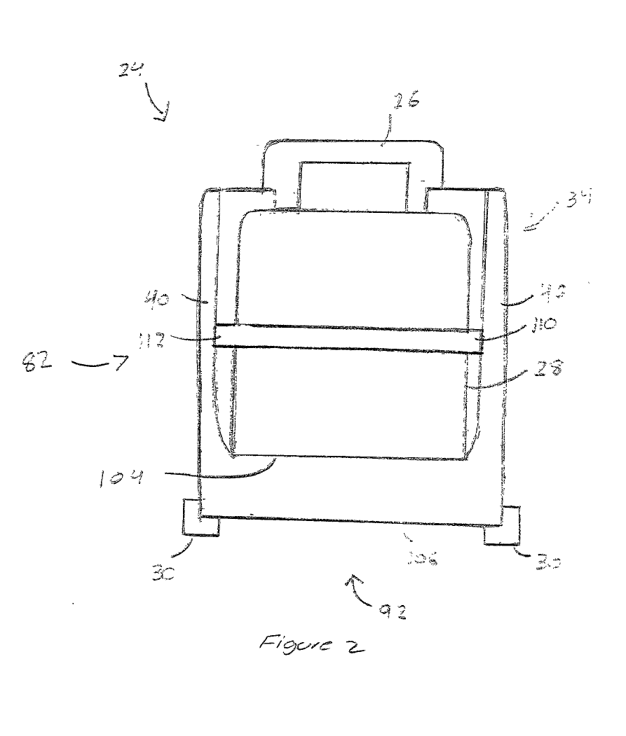

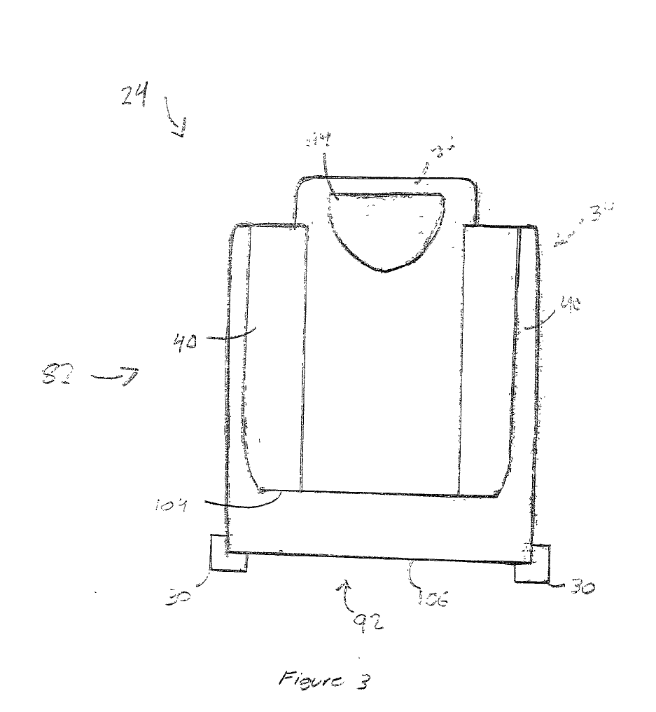

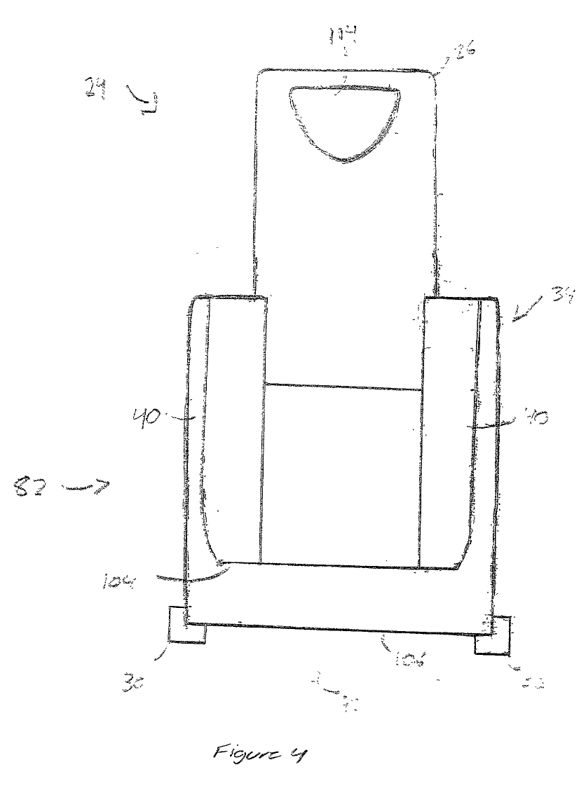

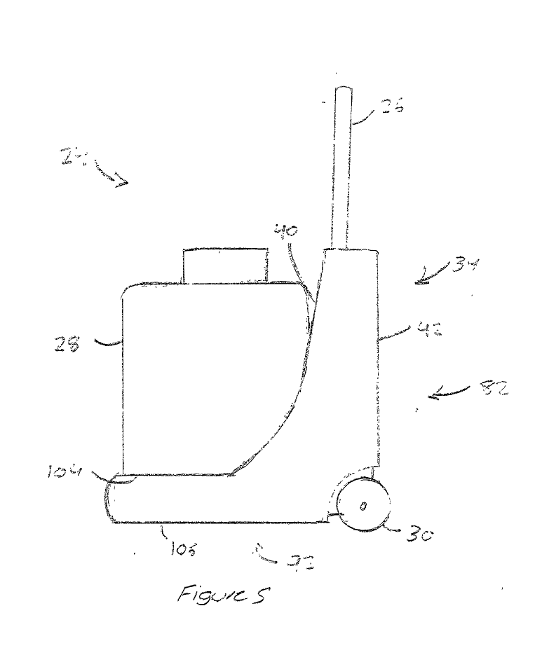

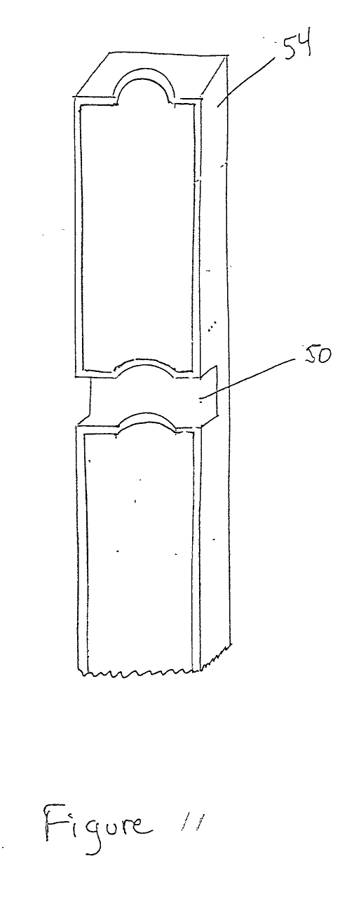

FIGS. 1-5 show the caddy 24, including a handle 26, a frame 82, and at least one wheel 30. In this embodiment, the handle 26 is adjustable and has an opening 114 (shown in FIG. 2) for receiving a user's hand and facilitating use of the handle 26. However, this is only one embodiment of the handle and any handle 26, chosen within sound engineering judgment, is within the scope of this invention. In this embodiment, there are two wheels 30 laterally spaced on opposite sides of the frame 82. The frame 82 has a base 92 and a back member 34, which extends upwardly from the base 92. In this embodiment, the base 92 has an annular shape. However, the annular shape of the base 92 is only one embodiment of the invention, and is not intended to limit the invention in any way. The base 92 includes first and second ends 104, 106. The first end 104 of the base 92 receives the gas tank 28 and holds the tank 28 in an upright position. In the preferred embodiment, the second end of the base 106 has a substantially circular opening 108 which also receives the gas tank 28 and further secures it to the caddy 24. The back member 34 has first and second sides 40, 42. The first side 40 is concave, which further secures the gas tank 28 to the caddy 24, and the second side 42 is substantially planar. The caddy 24 includes a securing means 110 (shown in FIG. 2), which is connected to the frame 82, to further secure the gas tank 28 to the caddy 24. In this embodiment, the securing means 110 is a strap 112, as shown in FIG. 2. However, any securing means 110, such as a rope or a cord, which adequately secures the gas tank 28 to the caddy 24 is within the scope of this invention. In this embodiment, the frame 82 and the handle 26 are rotationally molded, and are substantially hollow as shown in FIGS. 11, 12, 15, and 16. The caddy 24 can be designed to encompass any size cylindrical container, but in this embodiment, the caddy 24 is designed to hold a conventional 20 lb. propane gas tank 28. The conventional 20 lb. propane gas tank 28 is known within the art and denotes the standard size known within the industry. The propane gas tanks 28 are those used with the gas grill 10, which is used for home use. Any fuel source can be used, as long as it is chosen using sound engineering judgment.

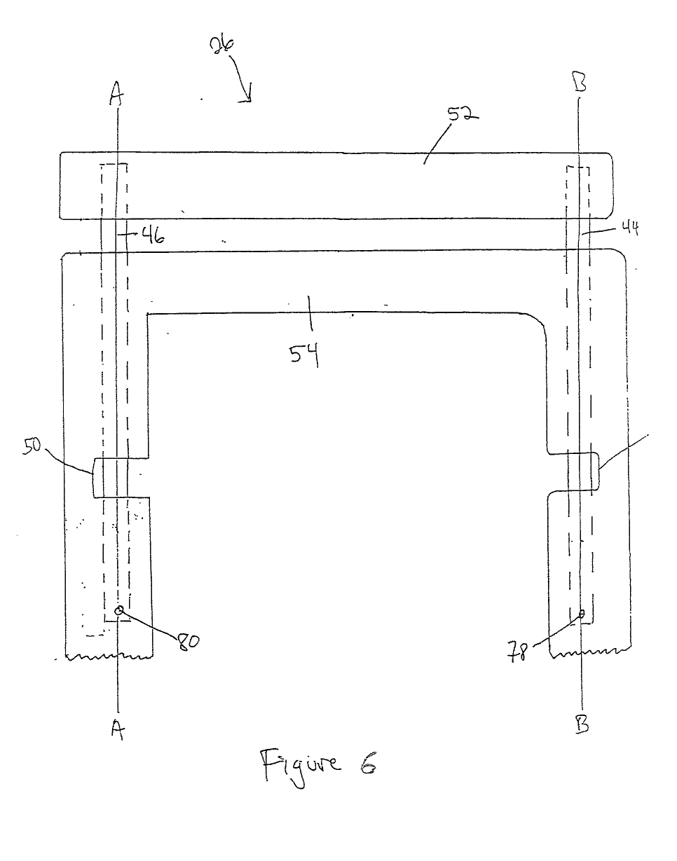

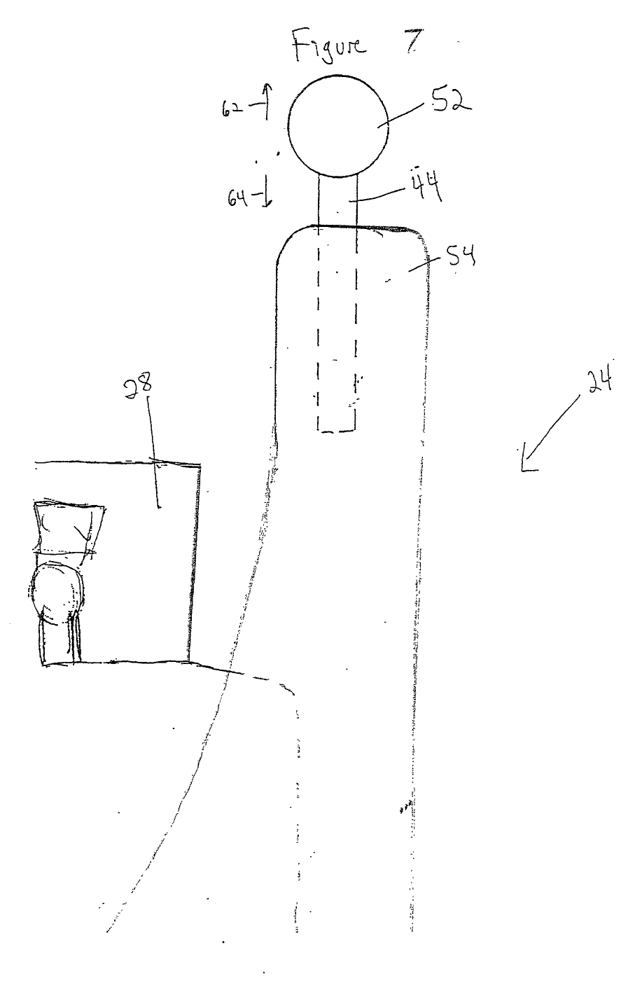

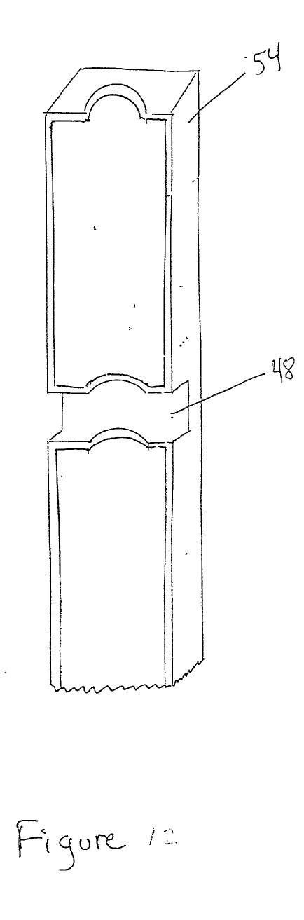

FIGS. 6 and 7 show another embodiment of the handle 26, shown in FIGS. 1-5. The handle described in FIGS. 6 and 7 is designated 26'. FIGS. 6 and 7 show a handle bar 52, a handle frame 54, first and second handle rods 44, 46, first and second handle rod stops 48, 50, and FIG. 7 shows the gas tank 28. The handle 26′ is adjustable as shown in FIGS. 6 and 7. FIGS. 11 and 12 show a cross-sectional view of the frame 54. The handle rods 44, 46 extend up and down vertically inside the frame 54.

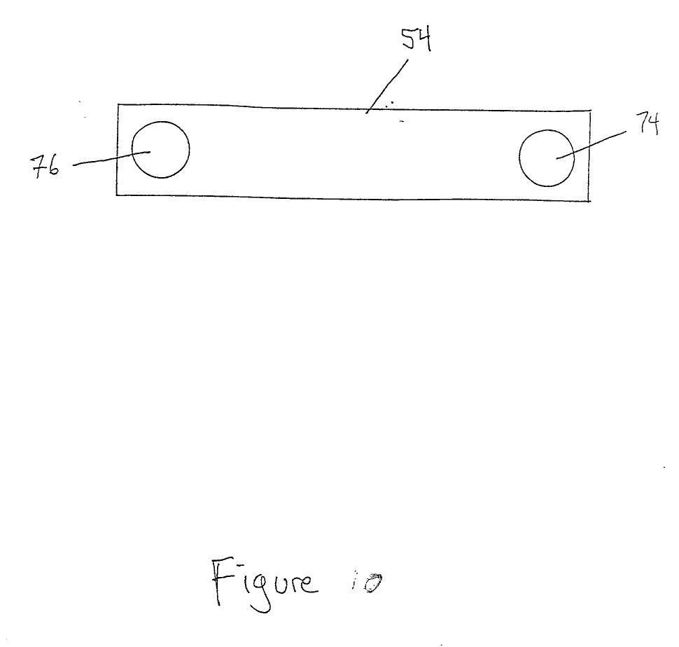

In FIG. 7, the handle bar 52 is adjustable in an upward direction 62, or a downward direction 64. The handle bar 52 can be extended from the frame 54 for easier transportation of the caddy 24. The handle rods 44, 46 are adjustably fitted in the handle rod guides 74, 76, as shown in FIG. 10. The handle rod stops 48, 50 prevent the handle rods 44, 46 from extending beyond the stops 48, 50. Each handle rod 44, 46 has a stop bar 78, 80 at the end of the handle rods 44, 46.

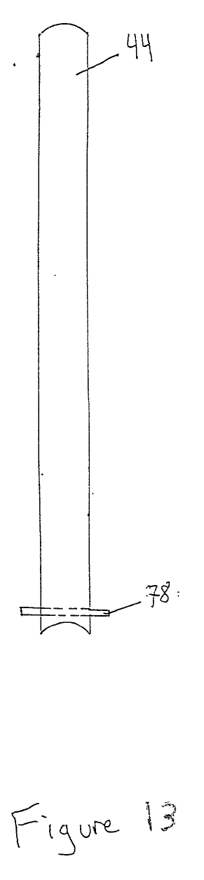

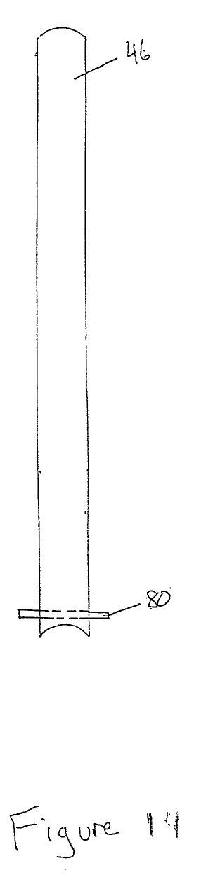

The first and second stop bars 78, 80, as shown in FIGS. 13 and 14, are thin rods that extend beyond the width of the handle rods 44, 46. When the handle rods 44, 46 are extended in an upward direction, the stop bars 78, 80 contact the handle rod stops 48, 50 and prevent further movement of the handle bar 52, and the handle rods 44, 46. The stop bars 78, 80 shown in FIGS. 6, 13, and 14 are shown as one embodiment of the invention, and are not intended to limit the invention in any way. Any means for extending the handle bar 52 to a specific height can be used.

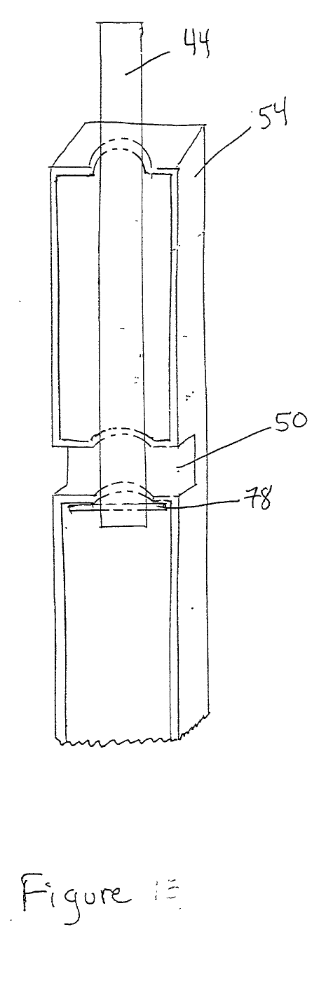

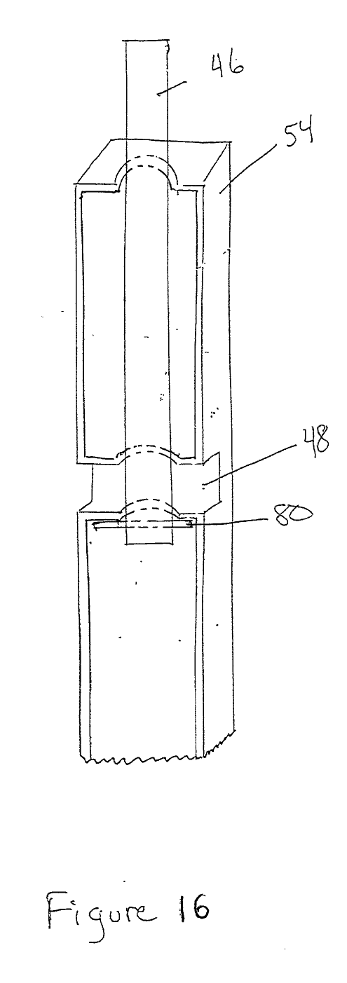

When the handle bar 52 is extended and the handle rods 44, 46 move up through the handle rod guides 74, 76, the stop bars 78, 80 extend outwardly, as shown in FIGS. 15 and 16, when the stop bars 78, 80 reach the handle rod stops 48, 50. The stop bars 78, 80 are only one embodiment of the invention and are not intended to limit it in any way. Any means for stopping the handle rods 44, 46 may be used, and any means for extending the stop bars 78, 80 may be used.

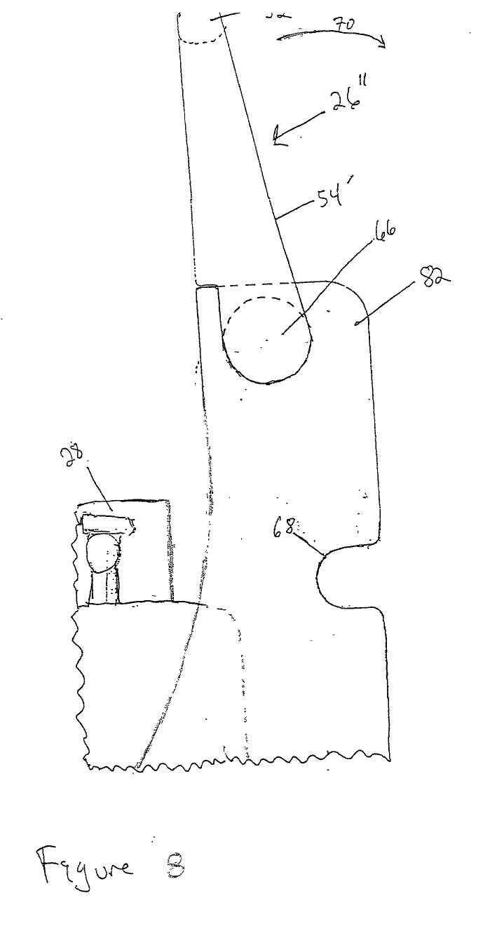

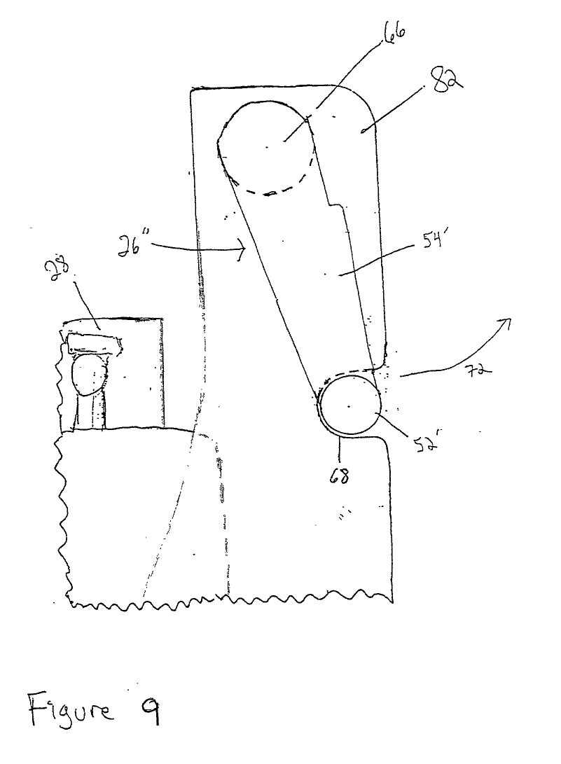

With reference now to FIGS. 8 and 9, another embodiment of the handle 26″ is shown. The handle 26″ shown in FIGS. 8 and 9 is a foldable handle. FIGS. 8 and 9 show the handle 26″, a handle bar 52′, a handle frame 54′, a pivot 66, and a handle bar receiving groove 68. The handle 26″ shown in FIG. 8 is in the extended position. The handle 26″ can move in a downward direction 70, and is rotatable about the pivot 66. The handle 26″ has a conventional locking mechanism (not shown) for locking the handle 26′ in the extended position.

As shown in FIG. 9, in the folded position, the handle bar 52′ fits within the handle receiving groove 68 in order to make the caddy 24 compact and easily storable. In order to extend the handle 26″, the handle bar 52′ and the handle 26″ can be moved in an upward direction 72. When in the handle receiving groove 68, the handle bar 52′ does not extend beyond the second side of the back member 42 (shown in FIGS. 1-5) of the caddy 24.

The previous descriptions of two embodiments of the handle 26, are only meant to show the aforementioned embodiments of the invention. The handle 26 can also be an integral part of the caddy 24. The handle 26, as shown in FIG. 1, can be a continuous extension of the frame 82. Whichever of the disclosed embodiments is chosen, the handle frame 54, handle frame 54′ (in the unfolded position as shown in FIG. 8) or the handle 26 needs to extend above the frame 82 far enough to allow the usery's hand to fit between the handle frame 54, handle frame 54′, or handle 26, and the gas tank 28. In other words, the space between the handle 26, the handle frame 54, or the handle frame 54′ (in the unfolded position as shown in FIG. 8), needs to be large enough for a human hand.

FIG. 12 shows an embodiment wherein the caddy 24 is used with an associated gas grill 10. The gas grill 10 includes a cooking surface (not shown), a grill frame 88, a hood 14, which includes an upper enclosure and a lower enclosure (shown, but not referenced), a control panel 12, used to control the amount of gas released, first, second, third, and fourth legs 16, 18, 20, 22, respectively, used to support the grill 10, and at least one support bar 32 used to attach the caddy 24 to the grill 10. The operation of the gas grill 10 is well known in the art and, for the sake of brevity, will not be described herein. In this embodiment, the second end of the base of the caddy 92 has first and second grooves 36, 38 for attaching the caddy 24 to the gas grill 10 and preventing lateral movement of the caddy 24. In use, the first and second grooves 36, 38 are placed substantially on the support bar 32 to secure the caddy 24 to the gas grill 10. In this embodiment, the wheel of the caddy 30 is used both for transporting the caddy 24 and for transporting the gas grill 10.

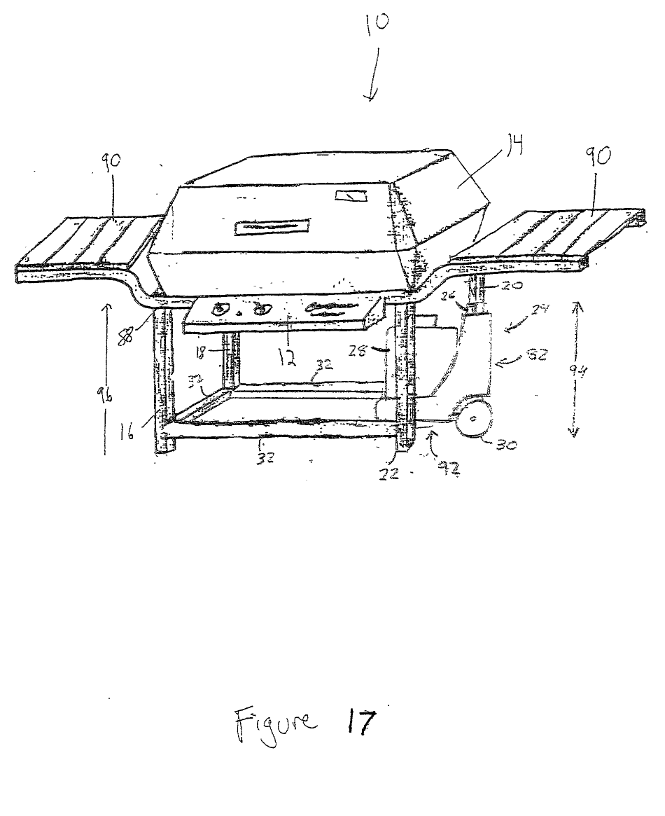

In this embodiment, the gas grill 10 has extensions 90, as shown in FIG. 17. The caddy 24 fits under the extensions 90. When the caddy 24 is in the attached position, the retracted handle 26′ (shown in FIG. 17) is at least 1″ below the extensions 90.

With reference now to FIG. 17, the gas grill 10 has a height 96 between the lower enclosure (shown, but not referenced) and the ground, and the caddy 24 has a height 94. In this embodiment, the caddy height 94 is less than the gas grill height 96. The difference between the height 96 of the gas grill 10 and the height 94 of the gas grill caddy 24 is large enough for the user's hand to fit in between the gas grill 10 and the handle 26′ of the caddy 24. However, the invention is not limited to a specific height of the caddy 24.

With reference now to FIGS. 1-17, the operation of the inventive gas grill 10 and gas grill caddy 24 will be described.

The gas tank 28 is placed in the base 92 of the caddy 24. In this embodiment, the handle bar 52 is extended by pulling the handle bar 52 in an upward direction and extending the rods 44, 46 upwardly until the rods 44, 46 reach the handle rod stops 48, 50. When the handle rods 44, 46 reach the handle rod stops 48, 50, the stop bars 78, 80 extend to prevent further movement of the handle rods 44, 46.

The caddy 24 can then be easily rolled, using the wheels 30, toward the gas grill 10. Once the caddy 24 is at the gas grill 10, the handle bar 52 can be retracted into a more storable position. The caddy 24 is then connected to the gas grill 10 using the support bar 32 and the grooves 36, 38. Once the caddy 24 is attached to the gas grill 10, the gas tank 28 can be connected to the gas grill 10 by any conventional delivering means for delivering the fuel to the lower enclosure (shown, but not referenced).

When the gas tank 28 is empty, the support bar 32 is removed from the grooves 36, 38. The caddy 24 is then pulled away from the gas grill 10 and the handle bar 52 is extended for easier transportation of the caddy 24. The caddy 24 is pulled, via the handle 26′, to a vehicle (not shown), for transportation of the gas tank 28.

The invention has been described with reference to the preferred embodiment. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

I claim:

1. A caddy comprising:
a frame, said frame having a base and a back member;
said base having a first end, said first end being adapted to receive an associated container in an upright position;
said back member extending substantially upwardly from said base;
at least one wheel attached to said frame; and,
a handle connected to said frame.

2. The caddy of claim 1 wherein said back base has a second end, said second end having two laterally spaced grooves for receiving a support bar of an associated grill to prevent lateral movement of said caddy.

3. The caddy of claim 1 wherein the base is annular.

4. The caddy of claim 3 wherein said second end of said base has a substantially circular opening.

5. The caddy of claim 1 wherein said handle is adjustable.

6. The caddy of claim 1 wherein said frame has first and second sides, said first side being substantially concave and said second side being substantially planar.

7. The caddy of claim 1 further comprising two laterally spaced wheels.

8. The caddy of claim 1 further comprising a securing means for securing the associated container to said caddy.

9. The caddy of claim 8 wherein said securing means is chosen from the group comprising a cord, a rope, and a strap.

10. The caddy of claim 1 wherein the associated container is a propane or natural gas tank.

11. The caddy of claim 10 wherein said propane or natural gas tank is a standard 20 lb. tank.

12. The caddy of claim 1 wherein the associated container is a bottle of water.

13. The caddy of claim 12 wherein said bottle of water is a standard five-gallon bottle.

14. The caddy of claim 1 wherein said handle and said frame are made of plastic.

15. The caddy of claim 14 wherein said handle and said frame are hollow.

16. A gas grill comprising:
a cooking surface;
an upper and lower enclosure;
a control panel;
a fuel source;
delivering means for delivering said fuel source to said lower enclosure;
a supporting means for supporting said lower enclosure;
a support bar; and,
a caddy to transport and store said fuel source, said caddy having a frame, a handle, at least one wheel, and a height, said frame having a base and a back member, said base having first and second ends, said first end being adapted to receive said fuel source in an upright position, said second end having two lateral spaced grooves for receiving said support bar, said handle being connected to said frame, said at least one wheel attached to said frame, said height of said caddy being less than said height of said grill from said bottom of said lower enclosure to the ground.

17. The gas grill of claim 16 wherein said base is annular.

18. The gas grill of claim 17 wherein said second end of said base has a substantially circular opening.

19. The gas grill of claim 16 wherein said handle is adjustable.

20. The gas grill of claim 16 wherein said frame has first and second sides, said first side being substantially concave and said second side being substantially planar.

21. The gas grill of claim 16 further comprising two laterally spaced wheels.

22. The gas grill of claim 16 further comprising a securing means for securing said fuels source to said caddy.

23. The gas grill of claim 22 wherein said securing means is chosen from the group comprising a cord, a rope, and a strap.

24. The gas grill of claim 16 wherein said fuel source is a 20 lb. propane or natural gas tank.

25. The caddy of claim 16 wherein said handle and said frame are made of plastic.

26. The caddy of claim 24 wherein said handle and said frame are hollow.

27. A method of transporting an associated gas tank, said method comprising the steps of:
providing a gas grill having a support bar;
providing a caddy having a frame, a handle, and at least one wheel, said frame having a base having first and second ends, said first end being adapted to receive said associated gas tank in an upright position, said second end having two lateral spaced grooves for receiving said support bar, said handle being connected to said frame, said at least one wheel attached to said frame;
placing said associated gas tank on said caddy;
transporting said associated gas tank to said gas grill on said caddy; and,
attaching said caddy to said associated gas grill.

28. The method of claim 27 wherein the step of attaching said caddy to said associated gas grill further comprises the step of positioning said two grooves substantially upon said support bar.

29. The method of claim 28 wherein said method further comprises the steps of:
detaching said caddy from said associated gas grill;
extending said handle transporting said empty associated gas tank to a desired destination; and,
retracting said handle.

30. The caddy of claim 1 wherein the caddy further comprises:
a center of gravity such that said back member is vertical when said caddy is empty.
